(19) United States
(12) Patent Application Publication
(10) Pub. No.: US 2009/0046706 A1
(43) Pub. Date: Feb. 19, 2009

(54) Managed Wireless Mesh Telephone Network And Method For Communicating High Quality Of Service Voice And Data

(76) Inventor: Fred Chernow, Boulder, CO (US)

Correspondence Address: LATHROP & GAGE LC, 4845 PEARL EAST CIRCLE, SUITE 300, BOULDER, CO, 80301, US

(21) Appl. No.: 12/192,423

(22) Filed: Aug. 15, 2008

Related U.S. Application Data
(60) Provisional application No. 60/956,367, filed on Aug. 16, 2007.

(51) Int. Cl. H04L 12/66

(52) U.S. Cl. 370/352; 370/400

(57) ABSTRACT

A telecommunications system includes a managed wireless mesh network capable of transmitting Internet Protocol (IP) packets therethrough, a controller in communication with the mesh network and in communication with the Public Switched Telephone Network, and a communication device in communication with the mesh network. The communication device converts a sound communication into at least one VOIP packet, and transmits and receives VOIP and non-VOIP packets to and from the mesh network, respectively. The packet containing the converted sound communication is set to a higher priority than a non-VOIP packet that does not contain the converted sound communication.

### RELATED APPLICATIONS

This Application claims benefit of priority to Provisional Application Ser. No. 60/956,367 filed Aug. 16, 2007, which is incorporated herein by reference.

### BACKGROUND

The present Application relates to mesh networks, and more particularly to mesh networks that can deliver both voice and data for telephone service and internet access.

In delivering voice services to telephone customers, how to access the customers is an issue of great significance. Conventional voice telephone service is typically delivered through the use of land lines, optical fiber, cable, or combinations thereof. Standard land lines have limited bandwidth and their infrastructure can be expensive to maintain. Optical fiber has much greater bandwidth than land lines, but is considerably expensive to install. Optical fiber is rarely, if ever, run directly to a customer, and is instead typically connected to land lines at some point before accessing the customer-provided telephone equipment. Cable service is also expensive to install.

### The Public Switched Telephone Network

The Public Switched Telephone Network (“PSTN”) is a network consisting of all of the world's public circuit switched telephone networks. It was originally a network of fixed-line analog telephone systems and is now almost entirely digital, and includes mobile as well as fixed telephones. The PSTN is largely governed by technical standards created by the International Telephone Union (ITU-T), and uses telephone numbers as addresses.

Prior to 1996, the Regional Bell Operating Companies (“RBOCs”) and a large number of smaller Independent telephone Companies were the only providers of fixed-line local telephone services in the United States. Services were typically provided using landlines of various bandwidths and optical fiber to interconnect their various Central Offices (COs) to each other and to the remainder of the Public Switched Telephone Network (PSTN) of which they were a part. The Telecommunications Act of 1996 created a new class of local telephone company known as a Competitive Local Exchange Carrier (CLEC). CLECs were required to have at a minimum one CO. FCC rulings required the RBOCs to lease their landline and optical fiber circuits to enable the CLEC to access their customers and connect to the rest of the PSTN via the RBOC's access and broadband networks. Rates for these services were governed by The FCC and were highly competitive. It was correctly analyzed by the FCC that multiple customer access networks would not result in competitive rates for the national customer base. This structure, however, created a new unforeseen problem. The CLECs were required to lease access to their customers from their competitors. Many CLECs sought ways of providing their own customer access. Some built optical fiber networks only to find the cost to be excessive.

### A Local Telephone Company Network

Referring now to FIG. 11, the structure of a typical local telephone company network 1100 is shown. The network 1100 typically includes a plurality of Tandem Central Offices (“Tandem COs”) 1103, which are connected to the remainder of the PSTN 1102, each other, and End Offices 1104, all of which are interconnected by high bandwidth digital circuits 1106. The high-bandwidth digital circuits 1106 are often referred to as intermachine trunks, and may include optical fiber. The users and potential users of telephone services at each user location 1108 are, most often, connected to the closest CO 1104 of the network 1100. Such user connections 1110 have been traditionally referred to as “entrance facilities.” Smaller telephone company networks may have one CO acting as both a tandem and end office CO.

Entrance facilities 1110 can be landline copper wire or optical fiber that a telecommunications company uses to connect its customers to the nearest CO Strung through the air (e.g., on telephone poles) or laid underground, entrance facilities are usually the costliest portion of the infrastructure of most telecommunication networks, and are thus the most difficult resource-intensive facilities for an startup company to duplicate. For such reasons, entrance facilities are often described as “bottlenecks,” with major regulation consequences associated with their creation.

Standard entrance facilities were originally designed to carry a single telephone call, and were typically formed by a twisted pair of copper wires. Approximately thirty-five years ago, advances in entrance facility technology made it possible to use two twisted pairs of copper wires to carry as many as twenty-four simultaneous telephone calls. Such newer entrance facilities, known as analog T1s, were used to meet the increased demand for service, but without a significant increase in the size of the infrastructure associated with the entrance facilities. Some time later, digital T1s and optical fiber were introduced as entrance facilities. However, even today, many residential and small business customers may still be physically connected to a CO through copper wires carrying one telephone line per twisted pair.

Referring again to FIG. 11, in a typical residential phone call scenario, human voice sounds are converted into corresponding analog electrical signals by a telephone set 1112(1) and transmitted over the entrance facility 1110(1) to the End Office 1104(1) servicing the location 1108(1) of the calling party. If the location 1108(2) of the party called is connected to another End Office 1104(2), the analog signals are usually digitized and sent over digital circuits 1106(1) to the End Office 1104(2) servicing the location 1108(2) of the called party where the digital signals are converted back to analog signals and sent to the called party's telephone over the called party's entrance facility 1110(2). In the case where a called party's entrance facility 1110(3) connects with the same End Office 1104(3) as the entrance facility 1110(4) of the calling party, the analog signals from/to each party are routed directly between the respective locations 1108(3), 1108(4) of the calling parties by the End Office 1104(3).

Business users with large amounts of telephone traffic and other service needs, such as direct internal dialing, often have the analog signals in their telephone systems digitized prior to reaching a digital entrance facility. Such users often use digital entrance facilities.

### Internet Service Over Telephone Lines

The proliferation of the use of personal computers to communicate by email and access the public internet has led to ever-increasing requirements for data communication over existing telecommunications networks. Telephone modems were originally devised to convert digital signals from computers to analog signals, so that the computer signals could be communicated over traditional telephone analog entrance facilities. The demand for higher-speed data communication over such entrance facilities resulted in the appearance of Digital Service Line Asynchronous Multiplexers, which, when coupled with a Digital Subscriber Line (DSL) modem located at the user's location, increased the maximum usable transmission speed of the twisted pair analog entrance facility far beyond what was its traditional communication bandwidth.

Although DSL bandwidth levels are not guaranteed by local telephone service providers, bandwidths in the 10-megabit per second range (Mbps) are not uncommonly realized by individual users. The realized bandwidth is dependent on the distance of the customer's location 1008 to the Central Office 1004, and also to the existence of extraneous equipment in the line, such as coils and capacitors. When business applications require guaranteed high bandwidth service levels, broadband services (e.g., digital T1s) are typically used as entrance facilities for at least their internet services.

More recently, cable service providers have used cable entrance facilities to deliver telecommunication services other than just television services. Cable entrance facilities are capable of providing high-bandwidth data (internet) and voice (telephone) service simultaneously with existing television service.

Some service providers use the internet as a transmission medium for phone calls. Such providers require customers to have a high-bandwidth connection to the internet, with an analog telephone adaptor (“ATA”) located at the user's premises. When a phone call is initiated, the ATA converts the analog voice signals into digital packets known as Voice Over Internet Protocol (VOIP). The VOIP packets are then sent through the internet to another public internet connection in the proximity of the called party where additional provider equipment translates the digital packets back into conventional telephone signals to be passed via the local telephone company to the called party.

Although using VOIP packets over the public internet is in use today to deliver telephone calls, the internet was not designed for use with real time applications. Heavy traffic on the internet, for example, can cause internet phone call traffic to experience periods of silence, garbled sounds, or to be disconnected while still in progress.

Real-time problems with internet voice calls result from three main factors: (1) excessive latency between the arrival of sequential VOIP packets (i.e., gaps between sequential “voice” messages); (2) VOIP packets arriving out of sequence (i.e., voice sounds garbled from being converted out of order); and (3) lost VOIP packets. Although the economics of using VOIP over the Public Internet appears attractive at first, the practical reality of the diminished quality of service (“QOS”) issues, described above, has resulted in many customers trying the service and returning to the use of more conventional technology. Another disadvantage with the VOIP over the public internet model is that this class of local and long distance telephone service requires a high bandwidth connection to the public internet. The providers of this service often rely on the high-bandwidth connection to the public internet to be supplied by their competitors, who may discriminate against the use of VOIP packets.

### Wireless Mesh Networks

Mesh networking is a method of routing information and instructions between nodes. It allows for continuous connection configurations, and reconfigurations around broken or blocked paths, by “hopping” from node to node until the destination is reached. A mesh network whose nodes are all connected to each other is known as a fully connected network. Mesh networks differ from other networks in that the mesh network's component parts can all connect to each other via multiple hops. Mesh networks are also self-healing, i.e., the network can still operate even when a node breaks down or a connection goes bad. The network can reconfigure around the broken node or bad connection. Accordingly, a very reliable network may be formed.

The mesh network concept is applicable to wireless networks. A wireless mesh network is a specific application of mesh network architectures. Wireless mesh networks were originally developed for military applications, but have since undergone significant evolution. As the cost of radios plummeted, products evolved to support multiple radios per node in the mesh. Additional radios may provide specific functions, such as user access and/or backhaul services. The mesh node design has further become more modular. One node can now support multiple radio cards, with each card having a potential to operate at a different frequency from other cards in the node.

As shown in FIG. 12, a wireless mesh network 1200 is composed of a number of individual nodes 1202 that all have network routing capabilities. The nodes 1202 form a cooperative communication infrastructure. Individual user locations 1204 connect to the network 1200 via radio transceivers 1206 connected to a computer 1208.

Mesh networks, however, have not been used to provide separate voice communications service, except through the same VOIP technology used over the public internet. VOIP information comes through the mesh network as data destined to be sent to the public internet. Accordingly, such voice communication service over a wireless mesh network still suffers from the same QOS issues as VOIP over the public internet.

### SUMMARY OF THE INVENTION

This present application features a telecommunication system providing voice and internet services, but which may avoid the use of traditional landline entrance facilities. The system utilizes a wireless, self-healing, mesh network as the entrance facility to communicate between user locations and a CO. The mesh network is a packet switched or private internet network capable of providing high-speed communication of both voice and data. The mesh network is managed to prioritize the transmission of voice packets over data packets. This prioritization assures a high QOS for voice traffic, comparable to that of landline entrance facilities. The invention provides voice and internet service at a significantly decreased entrance facility cost with a QOS equivalent to that of landline entrance facilities.

In an embodiment, a method of transmitting sound communications includes the steps of converting a sound signal into at least one Voice Over Internet Protocol (VOIP) packet, sending the VOIP packet to at least one access point of a managed wireless mesh network, transmitting the VOIP packet through the managed wireless mesh network with a higher priority than a non-VOIP packet, determining a destination of the sound communication, delivering the VOIP packet to a user location of the managed wireless mesh network, if the destination is the user location, and converting the VOIP packet into a format suitable for transmission through the Public Switched Telephone Network, when the destination is not a user location of the mesh network, and then delivering the sound information to a portion of the Public Switched Telephone Network that does not include the managed wireless mesh network.

In an embodiment, a method of transmitting a telephone call from within a managed wireless mesh network includes the steps of determining whether the user location of the managed wireless mesh network is making a voice call or transmitting data, converting the information of the telephone call into VOIP packets if the telephone call is a voice call, transmitting the VOIP packets sequentially along a first fixed path through the mesh network from the first user location to a central office connected to the mesh network, determining at the central office whether the telephone call has a first destination that is a second user location of the managed wireless mesh network or a second destination that is a portion of the Public Switched Telephone Network (PSTN) external to the mesh network, and delivering the telephone call to one of the first and second destinations.

In an embodiment, a method of transmitting voice information and data through a managed wireless mesh network includes the steps of sending data to customer premise equipment (CPE), the data being in Internet Protocol (IP) packets, from a digital communication device at a user location, sending a voice communication to the CPE from a voice communication device at the user location, converting the voice communication into Voice Over Internet Protocol (VOIP) packets, setting the VOIP packets at a higher priority than the non-VOIP packets, transmitting the VOIP and non-VOIP packets to at least one access node of a managed wireless mesh network, routing the VOIP and non-VOIP packets through the mesh network to a central office of the network according to their priority settings, the VOIP packets being routed along a first shortest available fixed path, determining if the voice communication is destined for another user location of the managed wireless mesh network or destined for a portion of the PSTN external to the managed wireless mesh network, delivering the voice communication to the other user location or the external portion of the PSTN, and delivering the non-VOIP packets from the central office to the Public Internet.

In an embodiment, a telecommunications system includes a managed wireless mesh network capable of transmitting Internet Protocol (IP) packets therethrough, a controller in communication with the mesh network and in communication with the Public Switched Telephone Network, and a communication device in communication with the mesh network. The communication device converts a sound communication into at least one VOIP packet, and transmits and receives VOIP and non-VOIP packets to and from the mesh network, respectively. The packet containing the converted sound communication is set to a higher priority than a non-VOIP packet that does not contain the converted sound communication.

The nodes of the mesh network include access points that wirelessly transmit packetized voice and data to and from CPE at user locations and CO nodes that transfer voice and data to and from the CO. The packets received wirelessly by the access point from the CPE are passed through the self-healing, managed, wireless mesh network to a CO node, which passes them through an Ethernet connection to the CO. Packets received by the CO nodes from the CO are passed through the managed wireless network to an access point that wirelessly sends them to the CPE at the appropriate user location. Backhaul nodes may be used solely to transfer packets to and from access and CO nodes. The CPE includes a two-way radio (typically WI-FI) and an interactive access device (IAD). The two-way radio can be used to communicate with the CO node and may have an Ethernet in connection to, or incorporated in, the IAD. The IAD converts voice information into VOIP protocol, sets the priority of the VOIP packets, and passes the packets on to the two-way radio. The IAD also sets the priority of the IP data packets and passes them on to the two-way radio. IADs typically distinguish voice from data by the specific port of the IAD used to connect to a user's telephones and computers.

Should there be a VOIP telephone at the user location it can use the same specific port of the IAD as the user's computer. In such a case, the specific port of the IAD does not have to be used to distinguish a packet as VOIP (voice) or standard IP (data). There can still be a port designation in the packet header that is defined by the Internet Assigned Number Authority (IANA). The port designation differs for different types of packet information. For example VOIP is 5060/SIP, email is 25/SMTP or 110/POP3 (depending on if the email is outgoing or incoming) and the worldwide web is 80/HTTP. By examining the port designation in the packet header packets can be distinguished. This information can be used to differentiate between VOIP phone call packets and IP data packets. The packet priority can then be set by the IAD, or the nodes can be designed to distinguish VOIP from IP packets and treat the VOIP packets as high priority and the IP data packets as low priority. In either case, each node can transmit voice packets before transmitting data packets awaiting transmission, and each node can transmit data packets if there are no voice packets awaiting transmission.

Further supplementary aspects of the invention involve some or all of the following. The transmission of data packets from each node is interrupted to transmit a voice packet, which becomes available for transmission from that node. Transferring data packets is resumed from each node after transmitting all voice packets available for transmission from that node. Node selection for inclusion in the communication path is based on three requirements that cannot always be simultaneously satisfied: (1) to insure that the traffic at a particular node does not exceed its bandwidth; (2) to minimize the number of node hops between access points and CO nodes for VOIP packets; and (3) to be geographically closer to the destination node than the present node. The next node in the communication path is selected at each node following receipt of a packet and just prior to its transmission. Only properly functional nodes are selected as the next node. Transmission between all nodes is accomplished wirelessly.

Other aspects of the invention, and a more complete appreciation of the present invention, as well as the manner in which it achieves the above and other improvements, can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 is a block diagram of a telecommunications system embodying the present invention.

FIG. 2 is a block diagram of customer premise equipment in user locations of the telecommunications system shown in FIG. 1.

FIG. 3 is a block diagram of a node of the wireless mesh network shown in FIG. 1.

FIG. 4 is an illustration of the VOIP message portion of an IP packet used to communicate voice information between nodes of the network shown in FIG. 1.

FIGS. 5 and 6 are flowcharts illustrating functional aspects of each node of the mesh network shown in FIG. 4.

FIG. 7 is a block diagram of the CO node of FIG. 1 connected with the Central Office and the PSTN.

FIGS. 8-10 are flowcharts illustrating functional aspects of the Central Office and its CO node shown in FIG. 7.

FIG. 11 is a block diagram of a conventional PSTN telecommunications system.

FIG. 12 is a block diagram of a conventional PSTN wireless mesh network.

### DETAILED DESCRIPTION OF THE DRAWINGS

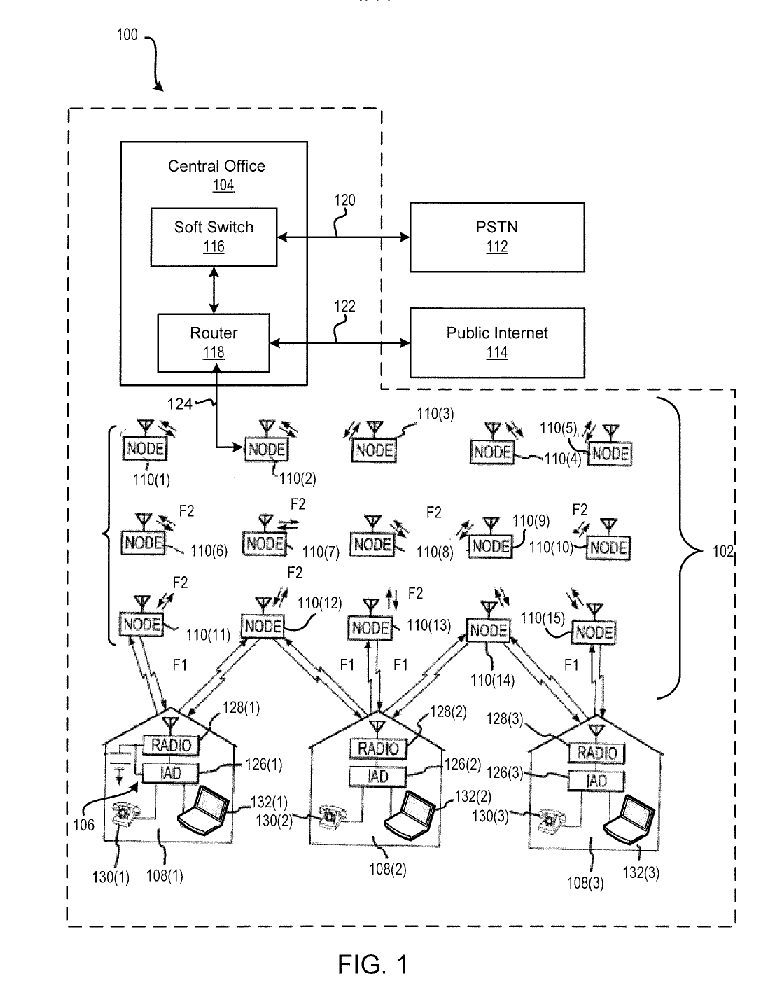

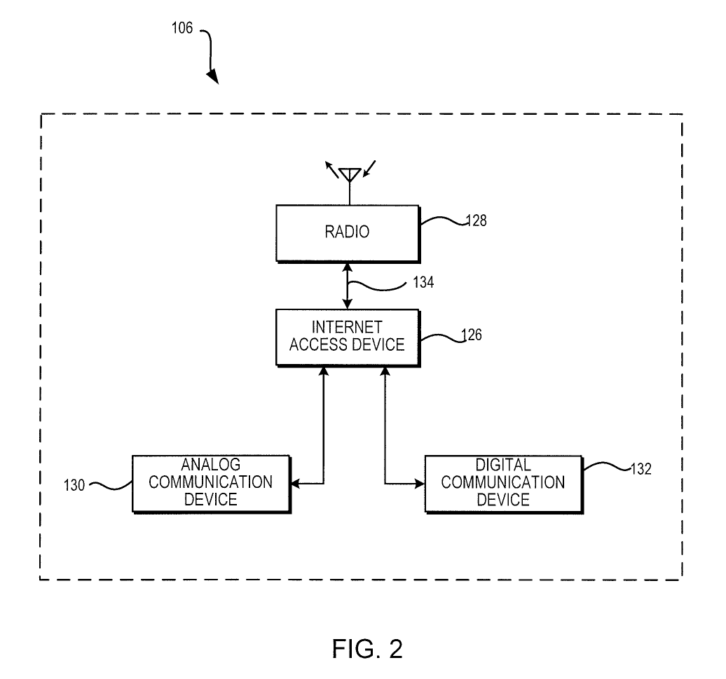

A telecommunications system 100 is shown in FIG. 1. The system 100 includes a wireless mesh network 102, a CO 104, and customer premise equipment (“CPE”) 106 (see also FIG. 2) that resides at a user location 108. The mesh network of FIG. 1 is shown as a 5 by 3 matrix of nodes 110, for example, but the network can take a different shape, and increase the number of nodes as desired. Three user locations 108(1)-108(3) are shown for the system 100 in FIG. 1, but the number of locations in the system can be as many as desired for the size and bandwidth of the mesh network 102. The mesh network 102 may be both self-healing and managed, and connects to both the PSTN 112 and the Public Internet 114 through the Central Office 104. Although technically, once in place, the system 100 is a part of the PSTN 112, for the purposes of this application, the PSTN 112 is conceptually referred to as a separate element than the system 100. It would be more factually correct to refer to element 112 as the remainder of the PSTN.

CO 104 includes, but is not limited to, a softswitch 116 and a router 118. Additional equipment may also be added for firewalls, encryption, bandwidth management, voice mail, etc., as known in the art. The router 118 interconnects the mesh network 102, the softswitch 116 and the Public Internet 114. The connection between the router 118 and the CO node (or nodes) 110(2) of the mesh network 102 may be via an Ethernet connection or connections 124. The connection between the router 118 and the softswitch 116 may also be via an Ethernet connection. The connection between the router 118 and the Public Internet 114 can be any of a variety of high bandwidth circuits 122. The softswitch 116 is connected to the PSTN 112 via LIS lines 120 (which may be DS3).

Softswitch 116 can be so configured so as to have two “identities,” one identity resembling a conventional CO, and the other a packet-switching CO for use in the system 100. Softswitch 116 may have the capability of transferring information from one CO identity to the other, thus permitting phone call traffic to pass between the telecommunication system 100 and the PSTN connection in the region of the system 100. Router 118 routes packets arriving from mesh network 102 to either the internet 114 or softswitch 116. Additionally, router 118 routes packets arriving from the internet 114 or softswitch 116 to the wireless mesh network 102.

The CPE 106 can be an interactive access device (“IAD”) 126 together with a radio device 128. IAD 126 is connected to a customer telephones or telephone system 130 and a computer or computer network 132 via wire connections to its ports (not shown). In an embodiment of CPE 106, as shown in FIG. 2, IAD 126 communicates with radio 128 via an Ethernet connection 134. Radio 128 communicates with mesh network 102 by transmitting and receiving packets from a node 110 of the mesh network, shown in the example of FIG. 1 as access nodes 110(11)-(15). Access nodes 110(11)-(15) are nodes in a wireless mesh network that wirelessly communicate voice and data information to and from user location 108 and mesh network 102. Communication is typically WI-FI (i.e., IEEE 802.11), although other standards such as WIMAX (i.e., IEEE 802.16), or other wireless standards, may be used. Telephone 130 may alternatively be an analog communication device that can receive analog voice signals and transmit them to the IAD 126. Computer 132 may alternatively be any of a number of digital communication devices that can access and/or work with the internet or other digital communication devices.

Referring back to FIG. 1, mesh network 102 may be a packet-switched radio network having nodes 110 that are capable of distinguishing packets by their respective priority. Based on such priority, mesh network 102 may modify the order that packets are transmitted from nodes 110 as well as the path through which packets are transmitted through the mesh network. There can be at least three different types of nodes 110 in mesh network 102. Two types of nodes provide the basic operation of the network 102, and the third type, often referred to as a “backhaul node,” is useful when the natural or man-made terrain on which the nodes 110 are located makes additional nodes necessary, and/or may increase QOS.

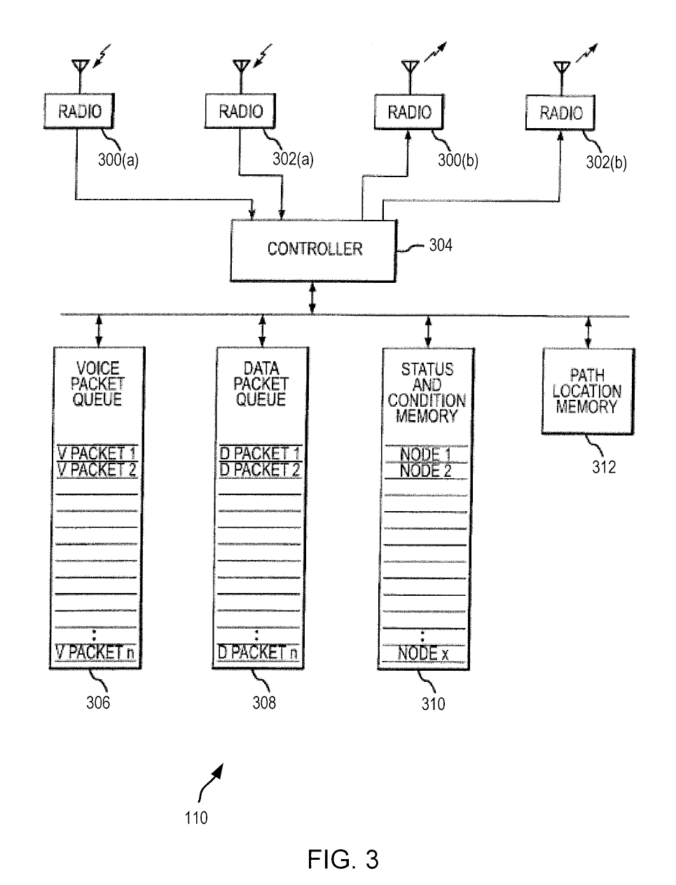

The first type of node, represented by access nodes 110(11)-(15), discussed above, should include two two-way radios (elements 300(a)-(b), 302(a)-(b), respectively, best seen in FIG. 3). The first radio is used to communicate with radio 128 at user locations 108 over a first frequency F1. The second radio is used to communicate with the remainder of mesh network 102 at a second frequency F2. The second type of node, represented by CO node 110(2), should have at least one two-way radio, operating at the second frequency F2, and a high bandwidth connection 124 to communicate with router 118 at CO 104, and connects to the remainder of the mesh network by radio via the second frequency. The third node type 110(1),(3)-(10) should have a minimum of two two-way radios, both operating at the second frequency F2, and is used for intra-node communication (i.e., from node-to-node). Although it is possible to build a mesh network with nodes 110 having a single two-way radio, having only a single radio may have a deleterious impact on the QOS. In some applications, it can be advisable to use three two-way radios to increase bandwidth and QOS, and/or provide access to the emergency service band at 4.9 GHz. Additionally, to minimize radio interference, the first and second frequencies, F1 and F2, discussed above, may be different. Typically, the second frequency F2 is performed in the 5 GHz range, and the first frequency F1 is performed in the 2.4 GHz range, although other frequencies and formats are also possible. One choice, such as 802.11n, for example, can be used to enhance bandwidth, but may cause interference with access node communications.

A basic configuration of one of the nodes 110, according to an embodiment, is shown in FIG. 3. The node 110 includes two two-way radios 300, 302. Each of the two-way radios includes a receiver portion, (a), and a transmitter portion, (b). Both portions of each radio 300, 302 connect with a controller 304, which itself connects with and manages at least one voice packet queue 306, data packet queue 308, status and condition memory 310, and path location memory 312. The controller 304 may control the operation and transmission of the radios 300, 302 according to the content and operation of the two packet queues 306, 308, and the two memories 310, 312.

The self-healing aspect of the mesh network 102 can be set according to the overlapping range of the radios located within nodes 110. Mesh network 102 can be arranged such that radio portions of a node 110 are in range of at least two other nodes 110. User locations 108 may be in radio range of four or more nodes 110. Nodes 110 communicate with each other such that if one node fails, the remaining nodes can be set, according to their status and condition memory 310 (FIG. 3) to no longer rely on the failed node for use by the network. Additionally, a report of the failed node is transmitted to the technical staff and/or equipment that monitors and manages the network.

The management aspect of the mesh network 102 can be set by assigning different priorities to the various types of packets to be transported. Voice packets (for the telephone voice service) are assigned a high priority, and data IP packets (typically, regular internet service, but may also be “modem-type” communication between telephones or receivers/modems connected to the PSTN instead of directly to the internet) are assigned a low, or no, priority. The mesh network 102 should be designed to recognize the priority levels of the packets and manage their transmission through the network. Management of the high priority packets (voice) can include one or more of the following components: always being transmitted from a node in the order of packet arrival, and prior to low priority packets (data); having a fixed path through the managed mesh network; and selecting the shortest path through the managed mesh network. According to this configuration, the system 100 is thus able to minimize latency (slow packet delivery), jitter (a burst of data, or change in the rate of packet arrival), and lost packets, and also to eliminate packets arriving in the wrong order. Thus, the problems associated with sending voice over the public internet 114 (and other non-managed packet networks) are mitigated.

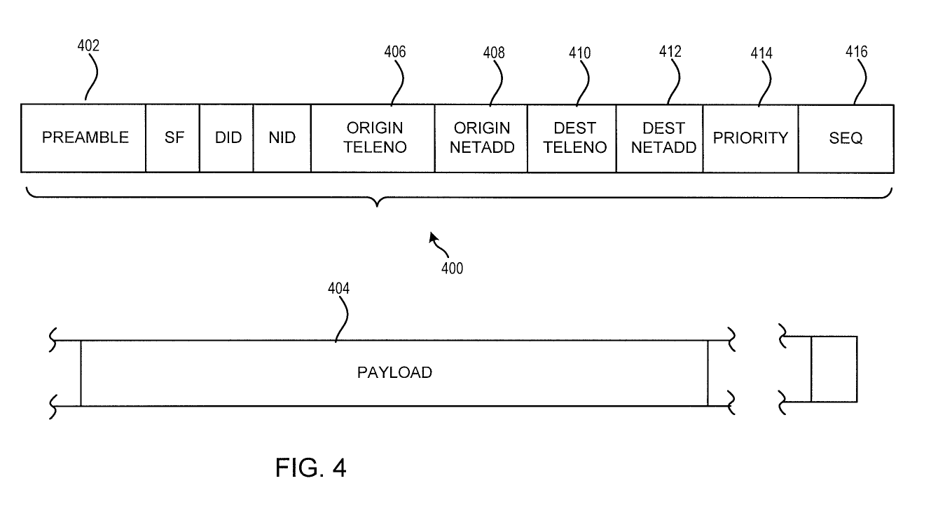

FIG. 4 illustrates a configuration of a digital IP packet 400 according to an embodiment, which may be a VOIP IP packet. For a voice communication/telephone call according to the system 100, the IP packet 400 can be used to communicate voice information between nodes 110 of the wireless mesh network 102. The packet 400 should include at least a preamble portion 402, and a payload portion 404 for the voice content of the packet (the payload would be data content, in the case of internet data). The packet 400 should also include a portion 406 for storing the initiating telephone number of a call, a portion 408 for storing the IP address of the initiating IAD 126, a portion 410 for storing the telephone number of the party being called, a portion 412 for storing the IP address of the called party's IAD 126 (if within the same system 100), a priority portion 414 for designating the higher priority of the voice message (this portion would have a low number, or be empty, for an internet data IP packet), and a portion 416 for designating the sequence of a particular packet in a series of packets in a queue.

A detailed description of the operation of the telecommunications system 100 is as follows. The packets transmitted through mesh network 102 are of various types of internet protocol (“IP”) packets 400. Packets are distinguished by the type of information being transported/transmitted. Voice communications are transmitted in a packet format known as VOIP. Computer data, on the other hand, is transmitted in IP data packets whose port designation in the transport layer of the IP packet defines these packets, as discussed further below.

The system 100 connects telephones 130 and computers 132, located in user locations 108, to other telephones 130 or customers of other telecommunications networks (such as PSTN 112), and other computers/computer networks 132, respectively. As an example, a customer may use a telephone 130(1) located in user location 108(1) to place a phone call to another telephone 130(2) at another user location 108(2), or to any customer's telephone connected to the PSTN 112, anywhere in the world. In another, or simultaneous, example, a customer at a user location 108 may use a computer 132 to explore websites on the internet 114, send and receive emails or send data files to other computers 132 within the system 100, or to other computers on the Public Internet 114.

The following events occur when voice and data communications are sent to/from user locations 108(1) and 108(2). Voice and data packets enter and exit mesh network 102 from/to both IAD 126(1) and IAD 126(2), located at user locations 108(1) and 108(2), respectively, and from/to router 118, located at CO 104. The router 118 sends all data packets originating from user location 108(1) to user location 108(2) and originating from user location 108(2) to user location 108(1). The router sends all voice packets from user locations 108(1) and 108(2) to the softswitch 116. The softswitch 116 determines the destination of the voice packets, upgrades the packet headers, and sends the packets back to the router 118. The router 118 then sends the packets to their appropriate destination. IP data packets enter and exit mesh network 102 from/to both IAD 126(1), located at user location 108(1), and router 118, located at CO 104. The router 118 sends/receives the data packets from/to the Public Internet 114.

The following events occur when voice and/or data communications are sent from user location 108(1) to a user location in the PSTN but not located in system 100. Voice and data packets enter and exit mesh network 102 from/to IAD 126(1) located at user location 108(1) and router 118 located at CO 104. The router determines that the data packets are not destined for the Public Internet (in this case, the data packets are the “modem-type” data that is sent between users directly through the telephone system), and sends and receives all of the voice and data packets from/to the softswitch 116 located in the CO 104. The softswitch 104 determines that the voice and data communications are destined for delivery to non system 100 users, converts the packets to formats acceptable for transmission through the PSTN and sends the reformatted communications from/to the PSTN and on to the appropriate user.

Referring back to FIG. 1, telephone call traffic initiated by a customer of the system 100 is processed as follows. A customer of the telecommunication system 100 at a user location 108(1) initiates a phone call by taking the telephone's handset “off-hook” (literally off-hook for wired telephones, or by pressing the “Talk” button, or the equivalent, for wireless or cellular telephones). The IAD 126(1) at the customer's user location 108(1) detects the off-hook condition, and sends the telephone 130(1) a dial tone signal. The customer then dials a called party's telephone number. The IAD(1) records the dialed number, constructs a digital VOIP packet 400 (see FIG. 4) containing the originating and terminating phone numbers (elements 406 and 410, respectively), the higher priority level (element 414) for voice, its IP address 408, the IP address of softswitch 116 at CO 104, and the appropriate message 404 to initiate a call. Each IAD 126 in use at user locations 108 may be preprogrammed with the phone numbers located at each of the IAD's telephone ports. The IAD 126(1) then passes the digital packet 400 to radio 128(1). Radio 128(1) wirelessly transmits the packet 400 to an access node 110(1)-110(5) of mesh network 102.

The digital packet 400 is then transferred through mesh network 102, through nodes 110 of adjacent radio ranges, to CO node 110(2). CO node 110(2) transmits the packet 400 to router 118 at CO 104. Router 118 sends VOIP packets 400 arriving from the mesh network 102 to softswitch 116. Softswitch 116 determines, from the VOIP IP packet 400, that a new phone call is being initiated. Softswitch 116 records the originating and destination phone numbers 406, 410, respectively, and the IP address 408 of the IAD 126(1) associated with initiating phone number 406. Softswitch 116 may then use an internal database (not shown) containing all customer phone numbers in the system 100, their respective features, and IAD IP addresses, to determine if the called party is served by the same mesh network 102, or else by a system other than, or outside of, system 100.

If the dialed number (stored in packet portion 410) of the called party appears in the internal database of the softswitch 116, then the same mesh network 102 serves the called party by routing the call back through the same mesh network 102, without having to connect the call to the PSTN 112. In an embodiment, softswitch 116 may also determine if the initiating phone number (stored in packet portion 406) has a feature known as caller ID blocking. Softswitch 116 creates a packet containing at least the IP address 412 of IAD 126(2) associated with the dialed phone number 410 and a message that a new phone call is being sent. If call blocking is not a feature of the originating phone number, the originating phone number 406 may also be added to the IP packet 400. The packet is then passed back to the router 118, onto CO node 110(2), through the mesh network 102, and to several of the access nodes 110(11)-(15) that are in radio range of the radio 128(2) of the called party in the network 102 (which should be connected to its own IAD 126(2)).

One of the access nodes 110(11)-(15) is designated by the mesh network to send the packet 400 to the radio 128(2), which then passes the packet to the IAD 126(2). The IAD(2) reads the packet 400, determines that a new phone call is to be established, and sends a ring tone to the appropriate telephone 130(2). The ring tone will cease when the called telephones 130 goes off-hook, if the originating party to the call hangs up or maybe after a pre-designated number of rings. If the telephone call is answered, a voice response from the dialed telephone/called party is packetized by the receiving IAD 126(2). The IP addresses 412 (see FIG. 4) of the receiving IAD 126(2) and the softswitch 116 are placed in IP packet headers, higher priority is set in packet portion 414, and the receiver's digital packets 400 are sent back through the radio 128(2), the access nodes 110(11)-(15), through the mesh network 102 to CO node 110(2), the router 118, and to the softswitch 116.

If the call is not answered after a pre-designated number of rings, the softswitch 116 may determine whether its internal database contains for the receiving phone number a feature that would require the softswitch 116 to send the digitized voice call to voicemail (not shown), or to forward the call to a different number if the call is not answered. With no such instruction, the softswitch 116 may just disconnect the caller path, thus terminating the call attempt.

If the softswitch 116 determines that the dialed number 410 is in use, the softswitch 116 may check the internal database to determine if some other action should be taken (e.g., a call waiting feature), and then performs that action. If no action is to be taken, a busy signal message should be sent to the IAD 126(1) servicing the initiating phone number 406. The IAD 126(1) then sends a busy signal tone to the initiating telephone 130(1). All of the foregoing actions include VOIP packet communications between the softswitch 116 and the IAD 126(1) servicing the initiating user location 108(1) phone number 406, which takes place in the manner described above.

If the dialed number 410 does not appear in the customer database, the softswitch 116 sends a request to the PSTN 112 over LIS line 120 to initiate a phone call to the dialed number 410. This request is sent to a CO of the PSTN 112 (typically a local or regional carrier), which processes the call in a similar manner to a request received to initiate a phone call from a CO within the telecommunication system of the PSTN 112. This request from the softswitch 116 to initiate the call should contain information in a format required by the PSTN 112. The remaining steps of the call will then parallel those of a call made to a customer within the telecommunication system 100, with the exception that the softswitch 116 converts all messages to be sent to the originating phone number into a format acceptable for use with the PSTN 112.

Telephone call traffic initiated by a customer of another telecommunication system is processed as follows. Phone calls originating from another telecommunication system enter the system 100 from the PSTN 112 via LIS lines 120 that terminate on the softswitch 116. The softswitch 116 uses its internal database to determine the address 412 of the IAD 126 servicing the particular phone number 410 dialed. The features of the dialed number 410 are checked, a VOIP packet is created containing a message 404 to inform the IAD 126 of the incoming call, the IP address 408 of the softswitch 116, and the IP address 412 of the IAD 126 servicing the phone number 410 dialed. From this point on, the call process is identical to that which occurs when a customer of the system 100 dials a phone number of another customer of the telecommunication system 100. The LIS line connection 120 and a path through the mesh network 102 are maintained throughout the length of the phone call.

For a call in progress between a customer of the system 100 and a customer of another telecommunication system, the softswitch 116 uses the information gathered when the call originated to continuously packetize the voice information and to transmit those packets 400 associated with the voice information to the appropriate user location 108 of the customer of the system 100, reformat packets 400 to the appropriate PSTN format, and send the reformatted packets through the appropriate LIS line 120 to the PSTN 112. The softswitch 116 addresses the packets to be sent to the correct IAD 126 by noting the LIS line 120 from which the call originated, maintains that connection throughout the duration of the call, and addresses all packets 400 associated with voice information arriving from the LIS line 120 to the IAD 126 originally selected when the dialed number arrived from the PSTN 112. The mesh network 102 maintains a path through its nodes 110 for the duration of the call.

Computer data between a computer 132 at a user location 108 and the internet 114 is processed and communicated as follows. A computer 132 sends an IP packet addressed to an internet address to the IAD 126 at its user location 108. The IAD adds either a low priority or no priority to the packet, and the address of the IAD then sends the IP packets to the radio 128. The radio 128 sends the IP packets to several access nodes 110(11)-(15) that are in radio range of the radio 128. The mesh network 102 selects one of the access nodes 110(11)-(15) to pass the IP data packets into the mesh network 102. The packets are passed through the network 102 at a low, or with no, priority to CO node 110(2). Because of the low/no priority designation, these data packets should only be transmitted from a node 110 in the mesh network 102 when there are no VOIP voice packets 400 to be transmitted from that same node 110. The path of an internet data packet through the mesh network 102 may thus vary depending on the traffic at other nodes 110. The CO node 110(2) sends the data packets to the router 118, which then sends the data packets to the internet 114.

IP packets arriving at the router 118 from the internet 114, with an IP address of an IAD 126 connected to a computer 132, are sent from the router 118 to CO node 110(2), passed through the mesh network 102, and on to the group of access nodes 110(11)-(15) in radio range of the radio 128 at the user location 108 where the IAD 126 destined to receive the packets is located. One of the access nodes 110(11)-(15) is designated by the mesh network 102 to send the IP packet onto the radio 128, and then on to the IAD 126, which passes the packets to the computer 132.

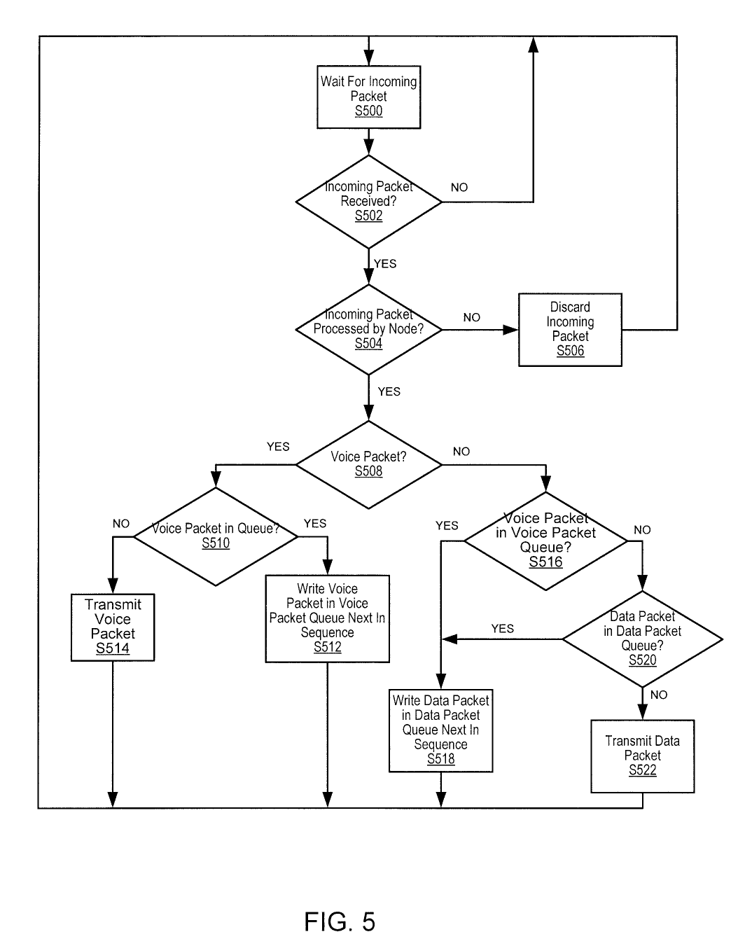

FIG. 5 illustrates functional process for the nodes 110 shown in FIG. 3. In an initial state at step S500, the node 110 waits for an incoming digital packet to reach the node. Step S502 is a decision step. In step S502, the node 110 checks whether a packet has been received. If no packet has been received, the node 110 remains in the initial state in step S500. If an incoming packet has been received, the node 110 continues on to decision step S504. In step S504, the node 110 determines whether the incoming packet is to be passed on by this node. If not, the node proceeds on to step S506 to discard the incoming packet, and then proceeds back to the initial state and step S500. If the incoming packet is to be processed by this node the node proceeds on to decision step S508.

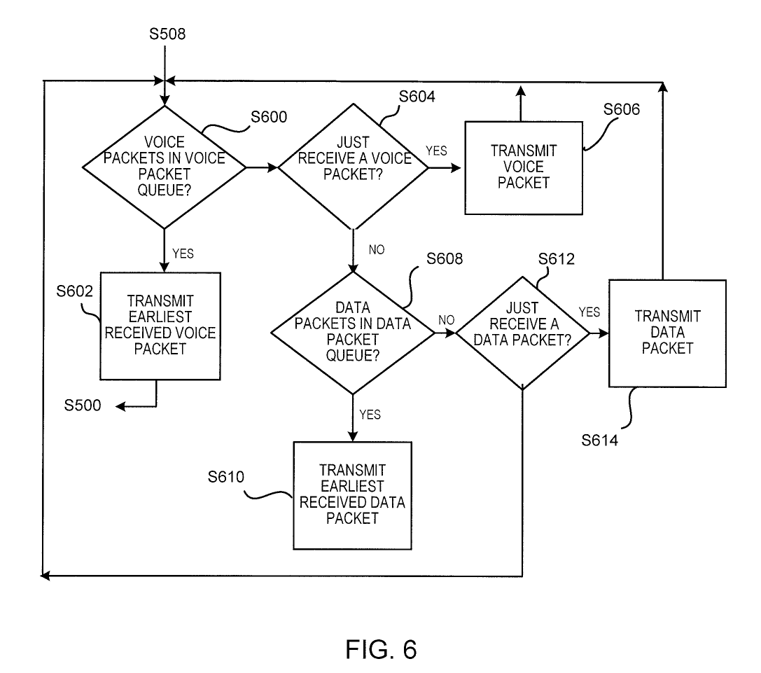

In step S508, the node 110 determines whether the incoming packet is a voice packet. If the packet is a voice packet, the node 110 proceeds to decision step S510. In step S510, the node 110 checks the voice packet queue 306 to determine whether there are voice packets waiting in the queue. If there are voice packets in the queue 306, the node 110 proceeds to step S512 and writes the voice packet into the queue 306 in the correct sequence, and reverts back to the initial state and step S500. If no voice packet is waiting in the queue 306, the node 110 proceeds to step S514 and immediately transmits the voice packet, after which the node returns to the initial state and step S500. During this process any voice packets in the voice packet queue 306 may be transmitted until the queue is empty, as discussed further below with respect to FIG. 6.

Referring back to decision step S508, if the node 110 determines that the incoming packet is a not a voice packet, i.e. the packet is a data packet, the node 110 proceeds to decision step S516, which is similar to step S510. Instep S516, the node 110 checks the voice packet queue 306 to determine whether there are voice packets waiting in the queue 306. If there any voice packets waiting in the queue 306, the node 110 proceeds to step S518 and writes the data packet into the data packet queue 308, in the correct sequence, and reverts back to the initial state and step S500. If there are no voice packets waiting in the voice packet queue 306, the node 110 proceeds to decision step S520 to determine first whether there are data packets waiting in the data packet queue 308. If the data packet queue 308 has data packets waiting, the node 110 proceeds to step S518 and writes the incoming data packet into the queue 308, in sequence. If there are no data packets waiting in the queue 308, the node 110 immediately transmits the data packet in step S522, after which the node returns to the initial state and step S500.

FIG. 6 illustrates an embodiment of the process shown in FIG. 5 from step S510, after the node 110 has determined that an incoming packet is a voice packet at step S508. Step S600 is a decision step that replaces step S510 in this embodiment. Like step S510, step S600 determines whether there are voice packets waiting in the voice packet queue 306. If voice packets are waiting in the queue 306, then the node 110 proceeds to step S602 and transmits the voice packet in the queue that was received earliest. After transmitting the earliest voice packet, the node returns to either the initial state at step S500, or to step S510 until all voice packets waiting in the queue 306 are transmitted. The embodiments of FIGS. 5 and 6 may be performed together.

If the node 110 determines at step S600 that no voice packets are waiting in the queue 306, the node proceeds on to step S604 to check whether a new voice packet has been received since the last check for an incoming voice packet (such as in step S508). If a voice packet has been received since the last check, the node 110 proceeds to step S606 and transmits the voice packet immediately, after which the node 110 returns to step S600. If it is determined at step S604 that no new voice packet has been received, the node proceeds to decision step S608 to check whether there are any data packets waiting in the data packet queue 308. If one or more data packets are waiting in the queue 308, the node 110 proceeds to step S610 and transmits the data packet that was received the earliest, after which the node returns to the initial state and step S500. If no data packets are waiting in the queue 308, the node 110 proceeds from step S608 to step S612 and checks whether a data packet has been received since the last check. If a new data packet has just been received since the last check, the node 110 proceeds on to step S614 and transmits that new data packet, after which the node returns to step S600. If it is determined at step S612 that no new data packet has just been received, the node 110 just proceeds back to step S600. This alternative processing flow can be useful during times of heavy traffic through the network 102.

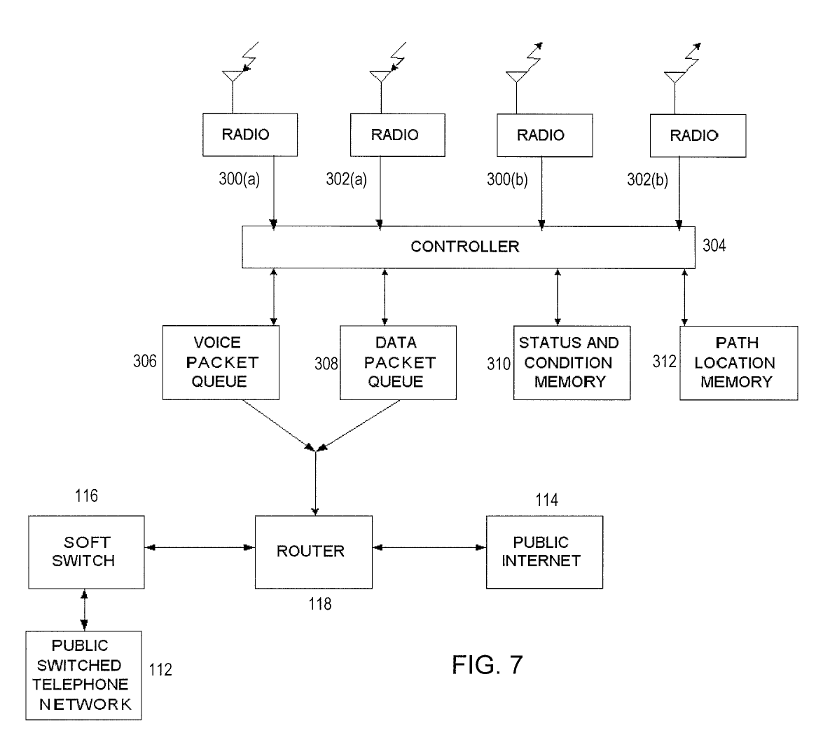

FIG. 7 is a block diagram showing interaction of the CO node 110(2) (see FIG. 1), the router 118, and the softswitch 116. All packets emanating from a user's CPE 106 enter the CO 104 through the router 118. The router 118 separates packets to be delivered to the softswitch from packets to be delivered to the Public Internet and routes them to the softswitch 116 and the Public Internet 114 respectively. The softswitch 116 determines if the voice (or data) packets are destined to be sent to another user location 108 of the system 100, in which case the softswitch 116 places the appropriate terminating address 412 on the packets and sends the packets back to the router 118 and onto the mesh network 102 for delivery. If the destination is found not to be another user location 108 of the system 100, the softswitch 116 converts the voice packet information to a format acceptable for use by the PSTN 112 and passes the information onto the PSTN.

It is also possible to connect a private line circuit from a system user location 108 (see FIG. 1) to a non-system user location (not shown) that is connected to the PSTN 112. In this case, both voice and data may be transmitted using the softswitch 116 to pass the information between user locations. Such a circuit should be dedicated on a PSTN portion and a Virtual Private Network (VPN) on the system portion of the circuit. The softswitch provides the information in a format acceptable to the equipment at the other end of the dedicated circuit.

Packets coming from the CO node 110(2) to the router 118 are routed to the softswitch 116 or the Public Internet 114. The softswitch 116 may send voice (or data) packets back through the router 118 to a user location 108 in the system 100, or convert the packets to a format suitable for use by the PSTN 112 and pass the packets to the PSTN for termination to a non-user of the system 100. If the packets are destined for the Public Internet 114, the router 118 sends the packets directly to the Public internet 114 without conversion. The controller 304 (see FIG. 3) may connect, in addition to queues 306, 308 and memories 310, 312 of the node 110(2), directly to the router 118 of the CO 104. In this embodiment, the softswitch 116 may further connect to and/or contain a local telephone number database (not shown) as described above, and the router 118 may similarly connect to and access a local internet address database (not shown) in the CO 104.

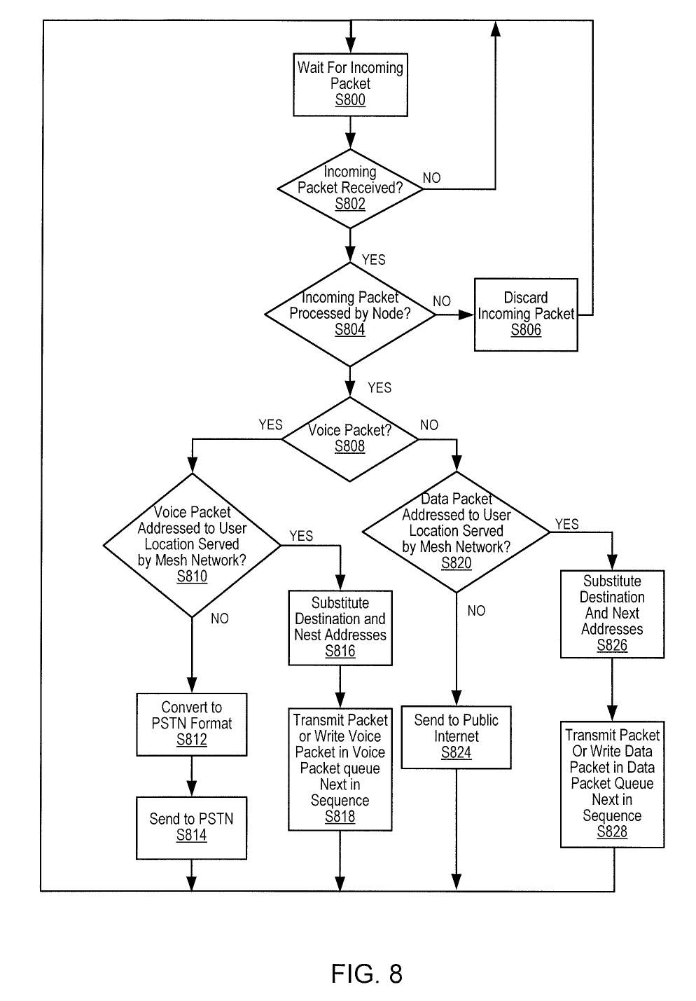

FIG. 8 illustrates an alternative functional process for the CO node 110(2) connected to the CO 104, as shown in FIG. 7. In an initial state at step S800, the node 110 waits for an incoming digital packet to reach the node. Step S802 is a decision step. In step S802, the node 110(2) checks whether a packet has been received. If no packet has been received, the node 110(2) remains in the initial state in step S800. If an incoming packet has been received, the node 110(2) continues on to decision step S804. In step S804, the node 110(2) determines whether the incoming packet is to be processed by the node. If not, the node proceeds on to step S806 to discard the incoming packet, and then proceeds back to the initial state and step S800. If the incoming packet is to be processed by the node, then the node proceeds on to decision step S808. Up to this point, the process is essentially identical to the process shown in FIG. 5.

All decisions concerning the destination of a voice and data packets are made at the softswitch 116 of the CO 104. If a VPN is set up between two user locations of the system 100, such information should also be contained in a database of the softswitch 116. The router 118 sends all IP packets arriving from user locations 108 of the system 100 and destined for the Public Internet 114, and all voice (and other data) packets to the softswitch 116. The process of the CO 104 may therefore differ after step S808, depending on the type of packet received. If, at step S808, the router 118 determines that the incoming packet is a voice packet, the CO 104 proceeds on to decision step S810.

In step S810, the softswitch 116 may determine whether the incoming voice packet is addressed to a user location 108 (see FIG. 1) served by the mesh network 102. If not, the softswitch 116 proceeds on to step S812 and converts the incoming packet to a format acceptable for use by the PSTN 112, and then sends the reformatted information to the PSTN 112 in step S814, after which the CO 104 returns the process to the initial state and step S800. If, however, at step S810, the softswitch 116 determines that the packet is addressed to a user location 108 served by the network 102, the softswitch 116 proceeds on to step S816 where it may substitute into the packet header the destination address 412 of the particular user location 108 destined to receive the packet. After substituting the destination address 412, the router 118 sends the packet to node 110(2) and the process proceeds on to step S818, where the node 110(2) will either transmit the packet or write the packet into its voice packet queue 306, after which the node 110(2) will continue to transmit packets into the mesh network 102. The CO 104 may then return the process to the initial state and step S800.

Referring back to step S808, if the router 118 determines that the incoming packet is not a voice packet, the router 118 proceeds onto decision step S820. In step S820, the router 118 determines whether the incoming data packet is addressed to a user location 108 served by the mesh network 102 or the Public Internet 114. If the packet is destined for the Public Internet 114, the router 118 sends the data packet to the Public Internet 114 in step S824, after which the CO 104 returns the process to the initial state and step S800. If, however, at step S820, the router 118 determines that the IP data packet is addressed to a user location 108 served by the network 102, the router 118 proceeds on to step S826 where it may substitute into the packet header the destination address 412 of the particular user location 108 destined to receive the packet. After substituting the destination address 412, the router 118 sends the packet to node 110(2), and then proceeds on to step S828, where node 110(2) will either transmit the packet or write the packet into its data packet queue 308. The CO 104 may then return the process to its initial state and step S800.

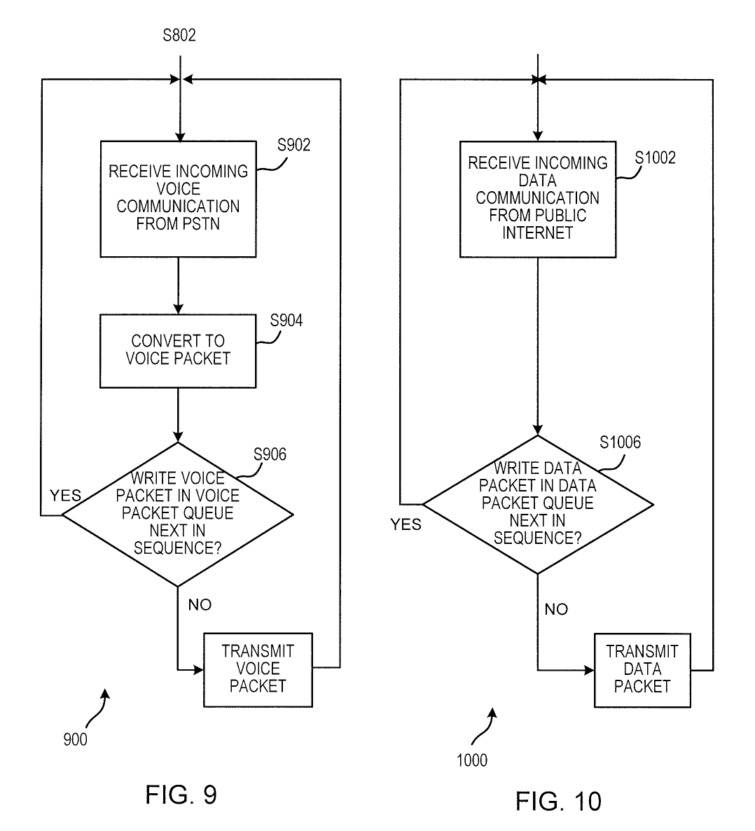

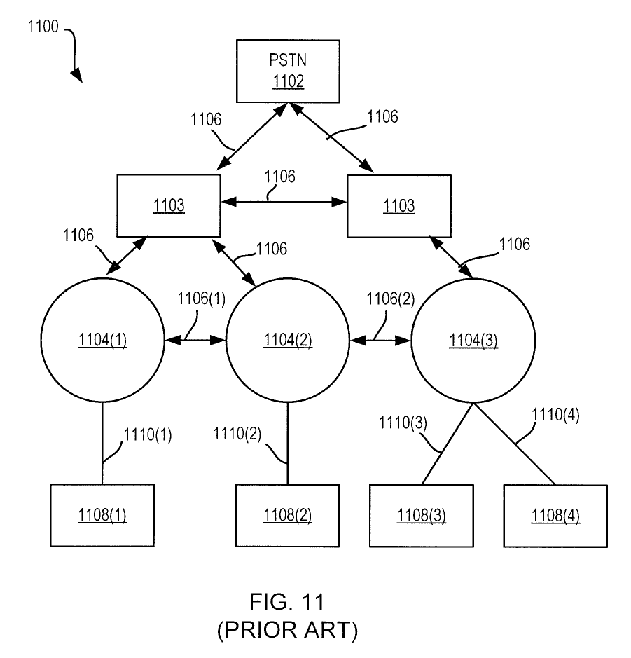

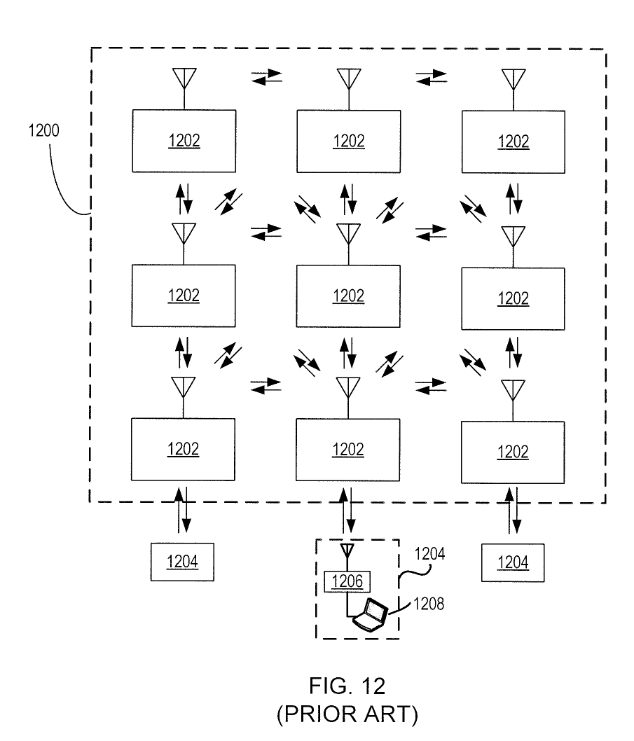

FIG. 9 illustrates an alternative or additional sub-process 900 of the CO 104 for voice communications or telephone calls coming into the system 100 from the PSTN 112. The sub-process 900 can begin from step S802 of the process shown in FIG. 8, but one of ordinary skill in the art, after reading and comprehending this application, will understand that this sub-processing may begin from one of many other steps in the process shown.

In the sub-process 900, an incoming voice communication from the PSTN 112 is received by the softswitch 116 of the CO 104 at step S902. The voice communication may be a telephone call, a voicemail message, or the like, and may be an analog or digital signal. At step S904, the softswitch 116 converts the voice communication into a digital voice packet, along the format illustrated in FIG. 4, adds the appropriate address, and sets the priority in the packet header, after which the softswitch 116 sends the packet onto the router 118. The router 118 reads the address, determines that the packet is to be sent to a user 108 of the system 100, and then sends the packet onto the CO node 110(2). In step S906, CO node 110(2) determines if there are any voice packets in its voice packet queue 306, if there are voice packets in the queue 306, the voice packet is written into the voice packet queue 306. If there are no voice packets in the voice packet queue 306, the packet is sent through the mesh network 102 for delivery to a user location 108. The sub-process 900 then returns to step S902, and the softswitch 118 of the CO 104 is ready to receive the next voice packet in the sequence.

FIG. 10 illustrates an alternative or additional sub-process 1000 of the CO 104 for data communications coming into the network 102 from the Public Internet 114. Similar to sub-process 900, above, the sub-process 1000 can begin from step S802 of the process shown in FIG. 8, or from one of many other steps in the process. In this sub-process 1000 the router 118 of the CO 104 receives an incoming data communication from the Public Internet 114 at step S1002, and then at step S1006, the data packet (the data already being in the proper format) is sent to the node 110(2). If there are voice packet in the node's 110(2) voice packet queue 306 or data packets in the data packet queue 308 the packet is written into the data packet queue 308. If there are no packets in either queue 306 or 308, the data packet is sent through the mesh network 108 for delivery to a system user 108. The sub-process 1000 then returns to step S1002, and the router 118 of the CO 104 is ready to receive the next data packet in the sequence.

A high QOS can therefore be realized by using the managed mesh network 102 and requiring the IADs 126 and the softswitch 116 to prioritize VOIP packets. Several additional factors will contribute to this high QOS. First, the managed mesh network 102 can be programmed to recognize and react to the higher priorities associated with VOIP packets. Second, VOIP packets arriving at any node 110 in the mesh network 102 should be transmitted in the order in which they arrive prior to the transmission of any data packets. Data packets should be transmitted (in the order they arrive) only when there are no voice packets to be transmitted. Third, the path for voice packets through the mesh network 102 should be selected to minimize the number of “hops” between nodes 110. Once a path for a voice call is established, it should be fixed for the duration of the phone call unless there is failure of one of the nodes 110 in the fixed path.

These factors reduce latency and jitter resulting from high data traffic volumes and call paths with an large number of hops between nodes. The fixed path ensures the packets arrive at their destinations in the order that the packets were sent, and keeping the fixed path with higher voice priority virtually eliminates packet loss. Should a node in the fixed path fail, or approach its bandwidth limit, the path may be altered to accommodate such conditions. In this manner, problems associated with the QOS of voice traffic over packet networks, such as the public internet, are virtually eliminated. The implementation of these several mesh network features is why the network is referred to as “managed.”

One other important consideration is useful to achieve a high QOS. The mesh network should be designed with sufficient bandwidth to accommodate the anticipated traffic. As network usage grows and network node bandwidth limits are approached, additional nodes should be added to ensure that VOIP packets will not be additionally queued at a node awaiting transmission. The bandwidth of the network should be sufficiently high to avoid such queuing.

What is claimed is:

1. A method of transmitting sound information, comprising the steps of:
converting a sound signal into at least one Voice Over Internet Protocol (VOIP) packet;
sending the VOIP packet to at least one access point of a managed wireless mesh network;
transmitting the VOIP packet through the managed wireless mesh network with a higher priority than a non-VOIP packet;
determining a destination of the sound communication;
delivering the VOIP packet to a user location of the managed wireless mesh network, if the destination is the user location; and
converting the VOIP packet into a format suitable for transmission through the Public Switched Telephone Network, when the destination is not a user location of the mesh network, and then delivering the sound information to a portion of the Public Switched Telephone Network that does not include the managed wireless mesh network.

2. The method of claim 1, wherein the step of transmitting the VOIP packet comprises setting a fixed transmission path through nodes of the managed wireless mesh network.

3. The method of claim 2, wherein at least one node along the fixed path will hold a non-VOIP packet in a data queue while transmitting the at least one VOIP packet.

4. The method of claim 3, wherein the at least one node will only transmit non-VOIP packets from the data queue if there are no VOIP packets at the at least one node.

5. A method of placing a telephone call from a user location of a managed wireless mesh network, comprising the steps of:
determining whether the user location of the managed wireless mesh network is making a voice call or transmitting data;
converting the information of the telephone call into VOIP packets if the telephone call is a voice call;
transmitting the VOIP packets sequentially along a first fixed path through the mesh network from the first user location to a central office connected to the mesh network;
determining at the central office whether the telephone call has a first destination that is a second user location of the managed wireless mesh network or a second destination that is a portion of the Public Switched Telephone Network (PSTN) external to the mesh network; and
delivering the telephone call to one of the first and second destinations.

6. The method of claim 5, wherein the step of transmitting the packets gives higher transmission priority to VOIP packets than to non-VOIP packets.

7. The method of claim 5, wherein the step of delivering the series of VOIP packets is performed by transmitting the series directly back through the managed wireless mesh network along a fixed path from the central office to the second user location.

8. The method of claim 5, further comprising the steps of:
converting at the central office a return voice communication from the PSTN into VOIP packets; and
transmitting the converted VOIP packets through the managed wireless mesh network along a second fixed path to the second user location from the central office.

9. A method of transmitting voice communication and data through a managed wireless mesh network, comprising the steps of:
sending data to customer premise equipment (CPE), the data being in Internet Protocol (IP) packets, from a digital communication device at a user location;
sending a voice communication to the CPE from a voice communication device at the user location;
converting the voice communication into Voice Over Internet Protocol (VOIP) packets;
setting the VOIP packets at a higher priority than the non-VOIP packets;
transmitting the VOIP and non-VOIP packets to at least one access node of a managed wireless mesh network;
routing the VOIP and non-VOIP packets through the mesh network to a central office of the network according to their priority settings, the VOIP packets being routed along a first shortest available fixed path;
determining if the voice communication is destined for another user location of the managed wireless mesh network or destined for a portion of the PSTN external to the managed wireless mesh network;
delivering the voice communication to the other user location or the external portion of the PSTN; and
delivering the non-VOIP packets from the central office to the Public Internet.

10. The method of claim 9, further comprising the steps of:
receiving at the Central Office, a return voice communication from one of the other user location and the external PSTN portion;
converting the voice communication into return VOIP packets if originating from the external portion of the PSTN;
receiving at the central office return non-VOIP packets;
setting the converted return VOIP packets to have the same priority level as the original VOIP packets, and the return non-VOIP packets to have the same priority level as the original non-VOIP packets;
transmitting the return VOIP and the return non-VOIP packets to at least one access node of the mesh network;
routing the return VOIP and the return non-VOIP packets through the mesh network according to their priority settings, the return VOIP packets routing along a second shortest available fixed path;
delivering the return VOIP and return non-VOIP packets to the CPE,
the CPE delivering the return non-VOIP packets to the digital communications device; and
the CPE converting the return VOIP packets into an appropriately-formatted voice communication, and sending the voice communication to the voice communications device.

11. A telecommunications system, comprising:
a managed wireless mesh network capable of transmitting Internet Protocol (IP) packets therethrough;
a controller in communication with the mesh network and in communication with the Public Switched Telephone Network; and
a communication device in communication with the mesh network, the communication device for converting a sound communication into at least one VOIP packet, and for transmitting and receiving VOIP and non-VOIP packets to and from the mesh network, respectively,
wherein the at least one packet containing the converted sound communication is set to a higher priority than a non-VOIP packet that does not contain the converted sound communication.

12. The system according to claim 11, further comprising controller that forms a central office having a router and a softswitch, the router being in communication with the mesh network and the softswitch.

13. The system according to claim 12, wherein the router is also in communication with the Public Internet.

14. The system according to claim 12, wherein the softswitch is in communication with the Public Switched Telephone Network.

15. The system according to claim 13, wherein the router includes an internet address database.

16. The system according to claim 14, wherein the softswitch includes a telephone address database.

17. The system according to claim 11, wherein the communication device includes at least one interactive access device for converting the sound communication and at least one two-way radio in communication with the mesh network.

18. The system according to claim 15, wherein the interactive access device is in communication with at least one sound communication device and at least one digital communication device.

19. The system according to claim 18, wherein the sound communication device is a telephone.

20. The system according to claim 18, wherein the digital communication device is a computer.

21. The system according to claim 11, wherein the mesh network comprises a plurality of nodes, each node comprising at least a first two-way radio.

22. The system according to claim 21, wherein a portion of the plurality of nodes includes at least a second two-way radio operational at a different frequency from the first two-way radio.
